(19) United States
(12) Patent Application Publication
(10) Pub. No.: US 2025/0037244 A1
(43) Pub. Date: Jan. 30, 2025

(54) High Dynamic Range View Synthesis from Noisy Raw Images

(71) Applicant: Google LLC, Mountain View, CA (US)

(72) Inventors: Benjamin Joseph Mildenhall, London (GB); Pratul Preeti Srinivasan, San Francisco, CA (US); Jonathan Tilton Barron, Alameda, CA (US); Richardo Martin-Brualla, Seattle, WA (US); Lars Peter Johannes Hedman, London (GB)

(21) Appl. No.: 18/709,218

(22) PCT Filed: Oct. 21, 2022
(86) PCT No.: PCT/US2022/047387

§ 371 Date: May 10, 2024

Related U.S. Application Data
(60) Provisional application No. 63/279,363, filed on Nov. 15, 2021.

(51) Int. Cl. G06T 5/60; G06T 5/50; G06T 5/70; G06T 5/92; G06T 15/20; G06T 19/20

(52) U.S. Cl. CPC G06T 5/60; G06T 5/50; G06T 5/70; G06T 5/92; G06T 15/205; G06T 19/20; G06T 2207/10024; G06T 2207/20081; G06T 2207/20084; G06T 2207/20208; G06T 2207/20212; G06T 2219/2012

(57) ABSTRACT

Systems and methods for training a neural radiance field model for noisy scenes can leverage raw noisy images in linear high dynamic range color space to train a neural radiance field model to generate view synthesis of low light and/or high contrast scenes. The trained model can then be utilized to accurately complete view rendering tasks without the preprocessing used for generating low dynamic range images. In some implementations, training on unprocessed data of a low light scene can allow for training a neural radiance field model to generate high quality view renderings of a low light scene.

### RELATED APPLICATIONS

This application claims priority to and the benefit of U.S. Provisional Patent Application No. 63/279,363, filed Nov. 15, 2021. U.S. Provisional Patent Application No. 63/279,363 is hereby incorporated by reference in its entirety.

### FIELD

The present disclosure relates generally to training a neural radiance field model on raw noisy images. More particularly, the present disclosure relates to training a neural radiance field model for generating view renderings for low light scenes by training the neural radiance field model on high dynamic range (HDR) images.

### BACKGROUND

Neural Radiance Fields (NeRF) can be utilized for novel view synthesis from a collection of input images and their camera poses. Like some other view synthesis methods, NeRF can utilize low dynamic range (LDR) images as input. These images may have gone through a lossy camera pipeline that smooths detail, clips highlights, and distorts the simple noise distribution of raw sensor data.

### SUMMARY

Aspects and advantages of embodiments of the present disclosure will be set forth in part in the following description, or can be learned from the description, or can be learned through practice of the embodiments.

One example aspect of the present disclosure is directed to a computing system. The system can include one or more processors and one or more non-transitory computer-readable media that collectively store instructions that, when executed by the one or more processors, cause the computing system to perform operations. The operations can include obtaining a training dataset. The training dataset can include a plurality of three-dimensional positions, a plurality of two-dimensional view directions, and a plurality of raw noisy images. In some implementations, the plurality of raw noisy images can include a plurality of high dynamic range images including a plurality of unprocessed bits structured in a raw format. The operations can include processing a first three-dimensional position of the plurality of three-dimensional positions and a first two-dimensional view direction of the plurality of two-dimensional view directions with a neural radiance field model to generate a view rendering. The neural radiance field model can include one or more multi-layer perceptrons. In some implementations, the view rendering can be descriptive of one or more predicted color values and one or more predicted volume density values. The operations can include evaluating a loss function that evaluates a difference between the view rendering and a first image of the plurality of raw noisy images. The first image can be associated with at least one of the first three-dimensional position or the first two-dimensional view direction. The operations can include adjusting one or more parameters of the neural radiance field model based at least in part on the loss function.

In some implementations, the operations can include processing the view rendering with a color correction model to generate a color corrected rendering. The loss function can include a reweighted L2 loss. In some implementations, evaluating the loss function that evaluates the difference between the view rendering and the first image of the plurality of raw noisy images can include mosaic masking. Evaluating the loss function that evaluates the difference between the view rendering and the first image of the plurality of raw noisy images can include exposure adjustment. In some implementations, the operations can include obtaining an input view direction and an input position, processing the input view direction and the input position with the neural radiance field model to generate predicted quad bayer filter data, and processing the predicted quad bayer filter data to generate a novel view rendering. The loss function can include a stop gradient. The stop gradient can mitigate the neural radiance field model generalizing to low confidence values. In some implementations, the first image can include a real-world photon signal data generated by a camera. The view rendering can include predicted photon signal data. In some implementations, the plurality of raw noisy images can be associated with a plurality of red-green-green-blue datasets.

Another example aspect of the present disclosure is directed to a computer-implemented method for novel view rendering. The method can include obtaining, by a computing system including one or more processors, an input two-dimensional view direction and an input three-dimensional position associated with an environment. The method can include obtaining, by the computing system, a neural radiance field model. The neural radiance field model may have been trained on a training dataset. In some implementations, the training dataset can include a plurality of noisy input datasets associated with the environment. The training dataset can include a plurality of training view directions and a plurality of training positions. The method can include processing, by the computing system, the input two-dimensional view direction and the input three-dimensional position with the neural radiance field model to generate prediction data. The prediction data can include one or more predicted density values and one or more predicted color values. The method can include processing, by the computing system, the prediction data with an image augmentation block to generate predicted view rendering. The predicted view rendering can be descriptive of a predicted scene rendering of the environment.

In some implementations, the image augmentation block can adjust a focus of the prediction data. The image augmentation block can adjust an exposure level of the prediction data. In some implementations, the image augmentation block can adjust a tone-mapping of the prediction data. Each noisy input dataset the plurality of noisy input datasets can include photon signal data. In some implementations, each noisy input dataset the plurality of noisy input datasets can include signal data associated with at least one of a red value, a green value, or a blue value. Each noisy input dataset the plurality of noisy input datasets can include one or more noisy mosaicked linear raw images.

Another example aspect of the present disclosure is directed to one or more non-transitory computer-readable media that collectively store instructions that, when executed by one or more computing devices, cause the one or more computing devices to perform operations. The operations can include obtaining a training dataset. The training dataset can include a plurality of raw input datasets. In some implementations, the training dataset can include a plurality of respective view directions and a plurality of respective positions. The operations can include processing a first view direction and a first position with a neural radiance field model to generate first predicted data. The first predicted data can be descriptive of one or more first predicted color values and one or more first predicted density values. The operations can include evaluating a loss function that evaluates a difference between the first predicted data and a first raw input dataset of the plurality of raw input datasets. In some implementations, the first raw input dataset can be associated with at least one of the first position or the first view direction. The operations can include adjusting one or more parameters of the neural radiance field model based at least in part on the loss function.

In some implementations, the one or more parameters can be associated with a learned three-dimensional representation associated with an environment. The loss function can include a tone-mapping loss associated with processing at least one of the first predicted data or the first raw input dataset. In some implementations, the operations can include processing a second view direction and a second position with the neural radiance field model to generate second predicted data. The second predicted data can be descriptive of one or more second predicted color values and one or more second predicted density values. The operations can include scaling the one or more second predicted color values based on a shutter speed to generate scaled second predicted data. The operations can include evaluating the loss function that evaluates the difference between the scaled second predicted data and a second raw input dataset of the plurality of raw input datasets. In some implementations, the second raw input dataset can be associated with at least one of the second position or the second view direction. The operations can include adjusting one or more additional parameters of the neural radiance field model based at least in part on the loss function.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs view rendering generation according to example embodiments of the present disclosure.

FIG. 1B depicts a block diagram of an example computing device that performs view rendering generation according to example embodiments of the present disclosure.

FIG. 1C depicts a block diagram of an example computing device that performs view rendering generation according to example embodiments of the present disclosure.

FIG. 2 depicts a block diagram of an example neural radiance field model according to example embodiments of the present disclosure.

FIG. 3 depicts a block diagram of an example neural radiance field model according to example embodiments of the present disclosure.

FIG. 4 depicts an illustration of an example view rendering pipeline according to example embodiments of the present disclosure.

FIG. 5 depicts a block diagram of an example neural radiance field model training according to example embodiments of the present disclosure.

FIG. 6 depicts a flow chart diagram of an example method to perform neural radiance field model training according to example embodiments of the present disclosure.

FIG. 7 depicts a flow chart diagram of an example method to perform novel view rendering according to example embodiments of the present disclosure.

FIG. 8 depicts a flow chart diagram of an example method to perform neural radiance field model training according to example embodiments of the present disclosure.

Reference numerals that are repeated across plural figures are intended to identify the same features in various implementations.

### DETAILED DESCRIPTION

### Overview

Generally, the present disclosure is directed to systems and methods training a neural radiance field model on noisy raw images in a linear high dynamic range (HDR) color space. For example, the systems and methods can utilize the noisy raw images in a linear HDR color space as input for training one or more neural radiance field models. Therefore, the systems and methods can bypass the lossy post processing that digital cameras apply to smooth out noisy images in order to produce visually appealing JPEG files. In some implementations, the systems and methods can assume a static scene and may intake camera poses as a given input.

The systems and methods disclosed herein can include obtaining a training dataset. The training dataset can include a plurality of three-dimensional positions, a plurality of two-dimensional view directions, and a plurality of raw noisy images. In some implementations, the plurality of raw noisy images can include a plurality of high dynamic range images comprising a plurality of unprocessed bits structured in a raw format. The systems and methods can include processing a first three-dimensional position of the plurality of three-dimensional positions and a first two-dimensional view direction of the plurality of two-dimensional view directions with a neural radiance field model to generate a view rendering. In some implementations, the neural radiance field model can include one or more multi-layer perceptrons, and the view rendering can be descriptive of one or more predicted color values and one or more predicted volume density values. Additionally and/or alternatively, the systems and methods can include evaluating a loss function that evaluates a difference between the view rendering and a first image of the plurality of raw noisy images. The first image can be associated with at least one of the first three-dimensional position or the first two-dimensional view direction. One or more parameters of the neural radiance field model can be adjusted based at least in part on the loss function.

In some implementations, the view rendering can be processed with a color correction model to generate a color corrected rendering. The loss function may include a reweighted L2 loss.

Additionally and/or alternatively, evaluating the loss function that evaluates the difference between the view rendering and the first image of the plurality of raw noisy images can include mosaic masking and/or exposure adjustment.

In some implementations, the systems and methods disclosed herein can optimize a neural radiance field model by optimizing a neural volumetric scene representation to match a plurality of images using a gradient descent based at least in part on a volumetric rendering loss. Additionally and/or alternatively, the systems and methods can utilize the optimization technique to reconcile content from a plurality of raw noisy images to jointly reconstruct and denoise the scene.

In some implementations, raw data (e.g., raw images) can include unprocessed bits saved by a camera in a raw format. Additionally and/or alternatively, HDR data (e.g., HDR images) can include one or more images that use more than the standard 8 bits to represent color intensities.

In some implementations, sRGB can denote the opposite of raw data (e.g., a fully postprocessed image that exists in a tonemapped LDR color space.

A neural radiance field (NeRF) model can include a multilayer perceptron (MLP) based scene representation optimized to reproduce the appearance of a set of input images with known camera poses. The resulting reconstruction can be used to render novel views from previously unobserved poses. NeRF's MLP network can intake a three-dimensional position and a two-dimensional viewing direction as input and can output volume density and color. To render each pixel in an output image, NeRF models can use volume rendering to combine the colors and densities from many points sampled along the corresponding three-dimensional ray.

Standard NeRF models can intake clean, low dynamic range (LDR) sRGB color space images with values in the range [0; 1] as input. Converting raw HDR images to LDR images can have two consequences: (1) detail in bright areas can be lost when values are clipped above at one, or heavily compressed by the tone-mapping curve and quantized to 8 bits; and (2) the per-pixel noise distribution can be no longer zero-mean after passing through a nonlinear tone-mapping curve and clipping values below zero.

The systems and methods disclosed herein (e.g., RawNeRF) can include modifying NeRF to use noisy raw images in linear HDR color space as input. The modification can enable the bypass of the lossy post processing that digital cameras apply to smooth out noisy images in order to produce visually acceptable JPEG files. Training directly on raw data can effectively turn RawNeRF into a multi-image denoiser capable of reconstructing scenes captured in near darkness. Unlike typical video or burst image denoising methods, RawNeRF can assume a static scene and expects camera poses as a given input. Provided with these extra constraints, RawNeRF can be able to effectively make use of three-dimensional multi-view consistency to average information across all of the input frames at once. Since the captured scenes can each contain 30-100 input images, this can in turn mean RawNeRF can be more effective than feed-forward burst/video denoisers that typically only make use of 3-8 input images for each output.

Additionally, since RawNeRF can preserve the full dynamic range of the input images, the systems and methods can enable HDR view synthesis applications that would not be possible with an LDR representation, such as varying the exposure setting and defocus over the course of a novel rendered camera path.

In some implementations, the systems and methods can modify NeRF to instead train directly on linear raw images, preserving the scene's full dynamic range. The systems and methods can allow the system to perform novel high dynamic range (HDR) view synthesis tasks, rendering raw outputs from the reconstructed NeRF and manipulating focus, exposure, and tone mapping after the fact, in addition to changing the camera viewpoint. Although raw data can appear significantly noisier than post processed images, the NeRF of the systems and methods disclosed herein can be highly robust to the zero-mean distribution of raw noise, producing a scene reconstruction so clean as to be competitive with dedicated single and multi-image deep denoising methods. This can allow the systems and methods (e.g., the RawNeRF implementation) to reconstruct scenes from extremely noisy images captured in near darkness.

HDR+ can complete HDR on handheld raw image bursts with very small motion. RawNeRF can handle very wide baseline motion and can also make a 3D reconstruction of the scene (but may utilize a static scene).

Neural Radiance Fields (NeRF) can be utilized for high quality novel view synthesis from a collection of input images and their camera poses. In some implementations, NeRF can utilize 8-bit JPEGs as input. The images may go through a lossy camera pipeline that smooths detail, clips highlights, and distorts the simple noise distribution of raw sensor data. The systems and methods disclosed herein can modify NeRF to instead train directly on linear raw images, preserving the scene's full dynamic range. The systems and methods can perform novel high dynamic range (HDR) view synthesis tasks, rendering raw outputs from the reconstructed NeRF and manipulating focus, exposure, and tone-mapping after the fact, in addition to changing the camera viewpoint. Although raw data may appear significantly noisier than post processed images, the systems and methods can show NeRF is highly robust to the zero-mean distribution of raw noise, producing a scene reconstruction so clean as to be competitive with dedicated single and multi-image deep denoising methods. The systems and methods can reconstruct scenes from extremely noisy images captured in near darkness.

The systems and methods can include obtaining a training dataset. The training dataset can include a plurality of three-dimensional positions, a plurality of two-dimensional view directions, and a plurality of raw noisy images. In some implementations, the plurality of raw noisy images can include a plurality of high dynamic range images comprising a plurality of unprocessed bits structured in a raw format. The systems and methods can include processing a first three-dimensional position of the plurality of three-dimensional positions and a first two-dimensional view direction of the plurality of two-dimensional view directions with a neural radiance field model to generate a view rendering. The neural radiance field model can include one or more multi-layer perceptrons. In some implementations, the view rendering can be descriptive of one or more predicted color values and one or more predicted volume density values. The systems and methods can include evaluating a loss function that evaluates a difference between the view rendering and a first image of the plurality of raw noisy images. The first image can be associated with at least one of the first three-dimensional position or the first two-dimensional view direction. The systems and methods can include adjusting one or more parameters of the neural radiance field model based at least in part on the loss function.

The systems and methods can obtain a training dataset. The training dataset can include a plurality of three-dimensional positions, a plurality of two-dimensional view directions, and a plurality of raw noisy images. The plurality of raw noisy images can include a plurality of high dynamic range images including a plurality of unprocessed bits structured in a raw format. In some implementations, the plurality of raw noisy images can be associated with a plurality of red-green-green-blue datasets. In some implementations, the plurality of raw noisy images can include bayer filter datasets generated based on raw signal data from one or more image sensors. The raw noisy image datasets can include data before exposure correction, color correction, and/or focus correction. The plurality of two-dimensional view directions and the plurality of three-dimensional positions can be associated with view directions and positions in an environment. The environment can include low lighting, and the plurality of raw noisy images can include low lighting.

A first three-dimensional position of the plurality of three-dimensional positions and a first two-dimensional view direction of the plurality of two-dimensional view directions can be processed with a neural radiance field model to generate a view rendering. The neural radiance field model can include one or more multi-layer perceptrons. In some implementations, the view rendering can be descriptive of one or more predicted color values and one or more predicted volume density values. The neural radiance field model can be configured to process a view direction and a position to generate one or more predicted color values and one or more predicted density values. The one or more predicted color values and the one or more predicted density values can be utilized to generate the view rendering. The view rendering can be a raw view rendering associated with one or more bayer filter images associated with one or more red, blue, or green filters. The raw view rendering may be processed with one or more image augmentation blocks to generate an augmented image with one or more corrected colors, one or more corrected focuses, one or more corrected exposures, and/or one or more corrected artifacts.

A loss function that evaluates a difference between the view rendering and a first image of the plurality of raw noisy images can then be evaluated. The first image can be associated with at least one of the first three-dimensional position or the first two-dimensional view direction. In some implementations, the loss function can include a reweighted L2 loss. Evaluating the loss function that evaluates the difference between the view rendering and the first image of the plurality of raw noisy images can include mosaic masking. Alternatively and/or additionally, evaluating the loss function that evaluates the difference between the view rendering and the first image of the plurality of raw noisy images can include exposure adjustment. In some implementations, the first image can include a real-world photon signal data generated by a camera. The view rendering can include predicted photon signal data.

The systems and methods can adjust one or more parameters of the neural radiance field model based at least in part on the loss function. The loss function can include a stop gradient. In some implementations, the stop gradient can mitigate the neural radiance field model generalizing to low confidence values.

In some implementations, the systems and methods can process the view rendering with a color correction model to generate a color corrected rendering. Alternatively and/or additionally, the view rendering can be processed with an exposure correction model to generate an exposure corrected rendering. The color correction model and/or the exposure correction model can be part of an image augmentation block. The one or more image correction models can be configured to process raw signal data and/or predicted raw signal data. The one or more image correction models can be part of an image augmentation model and can be trained on bayer filter signal data.

Additionally and/or alternatively, the systems and methods can include obtaining an input view direction and an input position, processing the input view direction and the input position with the neural radiance field model to generate predicted quad bayer filter data, and processing the predicted quad bayer filter data to generate a novel view rendering.

The trained neural radiance field model can then be utilized for novel view synthesis. For example, the systems and methods can include obtaining an input two-dimensional view direction and an input three-dimensional position associated with an environment. The systems and methods can include obtaining a neural radiance field model. The neural radiance field model may have been trained on a training dataset. The training dataset can include a plurality of noisy input datasets associated with the environment. In some implementations, the training dataset can include a plurality of training view directions and a plurality of training positions. The systems and methods can include processing the input two-dimensional view direction and the input three-dimensional position with the neural radiance field model to generate prediction data. The prediction data can include one or more predicted density values and one or more predicted color values. The systems and methods can include processing the prediction data with an image augmentation block to generate predicted view rendering. The predicted view rendering can be descriptive of a predicted scene rendering of the environment.

The systems and methods can obtain an input two-dimensional view direction and an input three-dimensional position associated with an environment. The environment can include one or more objects. In some implementations, the environment can include low lighting. The input view direction and the input three-dimensional position can be associated with a request for a novel view rendering that depicts a predicted view of the environment associated with the position and the view direction.

A neural radiance field model can then be obtained. The neural radiance field model may have been trained on a training dataset. The training dataset can include a plurality of noisy input datasets associated with the environment. In some implementations, the training dataset can include a plurality of training view directions and a plurality of training positions. Each noisy input dataset the plurality of noisy input datasets can include photon signal data. Additionally and/or alternatively, each noisy input dataset of the plurality of noisy input datasets can include signal data associated with at least one of a red value, a green value, or a blue value. In some implementations, each noisy input dataset the plurality of noisy input datasets can include one or more noisy mosaicked linear raw images.

The input two-dimensional view direction and the input three-dimensional position can be processed with the neural radiance field model to generate prediction data. The prediction data can include one or more predicted density values and one or more predicted color values. The prediction data can be utilized to generate predicted bayer filter data that can include predicted red filter data, predicted blue filter data, predicted first green filter data, and/or predicted second green filter data. The prediction data can be associated with predicted raw image data, which can be processed to generate refined image data.

The prediction data can then be processed with an image augmentation block to generate predicted view rendering. The predicted view rendering can be descriptive of a predicted scene rendering of the environment. In some implementations, the image augmentation block can adjust a focus of the prediction data. Additionally and/or alternatively, the image augmentation block can adjust an exposure level of the prediction data. The image augmentation block can adjust a tone-mapping of the prediction data.

Alternatively and/or additionally, the systems and methods can include obtaining a training dataset. The training dataset can include a plurality of raw input datasets. In some implementations, the training dataset can include a plurality of respective view directions and a plurality of respective positions. The systems and methods can include processing a first view direction and a first position with a neural radiance field model to generate first predicted data. The first predicted data can be descriptive of one or more first predicted color values and one or more first predicted density values. The systems and methods can include evaluating a loss function that evaluates a difference between the first predicted data and a first raw input dataset of the plurality of raw input datasets. In some implementations, the first raw input dataset can be associated with at least one of the first position or the first view direction. The systems and methods can include adjusting one or more parameters of the neural radiance field model based at least in part on the loss function.

A training dataset can be obtained. The training dataset can include a plurality of raw input datasets. In some implementations, the training dataset can include a plurality of respective view directions and a plurality of respective positions. The plurality of respective view directions can include a plurality of two-dimensional view directions. The plurality of respective positions can include a plurality of three-dimensional positions. The raw input datasets can include one or more high dynamic range images.

A first view direction and a first position can be processed with a neural radiance field model to generate first predicted data. The first predicted data can be descriptive of one or more first predicted color values and one or more first predicted density values. The first predicted data can be associated with predicted raw photon signal data.

A loss function that evaluates a difference between the first predicted data and a first raw input dataset of the plurality of raw input datasets can then be evaluated. The first raw input dataset can be associated with at least one of the first position or the first view direction. In some implementations, the loss function can include a tone-mapping loss associated with processing at least one of the first predicted data or the first raw input dataset. The loss function can penalize errors in dark regions more heavily than light regions in order to align with how human perception compresses dynamic range. The penalization can occur after both the first prediction data and the first raw input dataset are passed through a tone-mapping curve before loss function evaluation. In some implementations, the loss function can include a weighted loss function. The loss may be applied to the active color channels of a mosaiced raw input data and/or the first predicted data. Additionally and/or alternatively, camera intrinsics can be utilized to account for radial distortions when generating rays.

One or more parameters of the neural radiance field model can then be adjusted based at least in part on the loss function. The one or more parameters can be associated with a learned three-dimensional representation associated with an environment. In some implementations, the one or more parameters can be adjusted to learn the environment.

In some implementations, the computing system can train the neural radiance field model on an environment using image data generated using differing shutter speeds. For example, the computing system can process a second view direction and a second position with the neural radiance field model to generate second predicted data. The second predicted data can be descriptive of one or more second predicted color values and one or more second predicted density values. The computing system can scale the one or more second predicted color values based on a shutter speed to generate scaled second predicted data. The loss function that evaluates the difference between the scaled second predicted data and a second raw input dataset of the plurality of raw input datasets can then be evaluated. The second raw input dataset can be associated with at least one of the second position or the second view direction. One or more additional parameters of the neural radiance field model can be adjusted based at least in part on the loss function.

The systems and methods of the present disclosure provide a number of technical effects and benefits. As one example, the system and methods can train a neural radiance field model on raw noisy images. More specifically, the systems and methods can utilize unprocessed images to train a neural radiance field model. For example, in some implementations, the systems and methods can include training the neural radiance field model on a plurality of raw noisy images in a linear HDR color space. The neural radiance field model can then be utilized to generate a view rendering of a scene.

Another technical benefit of the systems and methods of the present disclosure is the ability to generate view renderings for low light scenes. For example, the neural radiance field models may be trained on data from the low light scene, and the resulting trained model can then be utilized for novel view rendering of the low light scene.

Another example technical effect and benefit relates to the reduction of computational cost and computational time. The systems and methods disclosed herein can remove the preprocessing step for training a neural radiance field model. The utilization of HDR images instead of LDR images can remove the processing steps for correcting raw images.

With reference now to the Figures, example embodiments of the present disclosure will be discussed in further detail.

### Example Devices and Systems

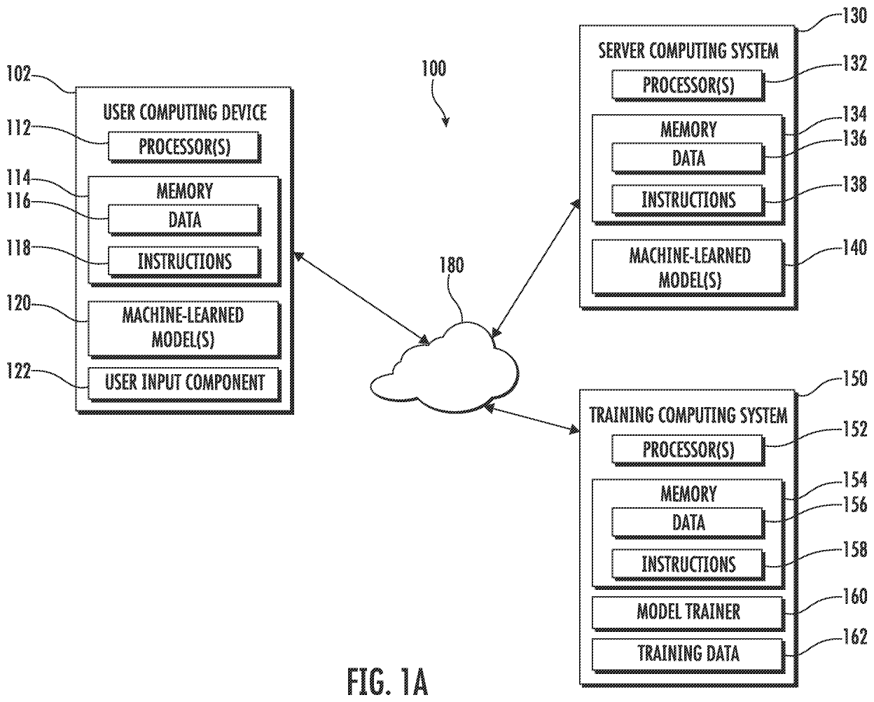

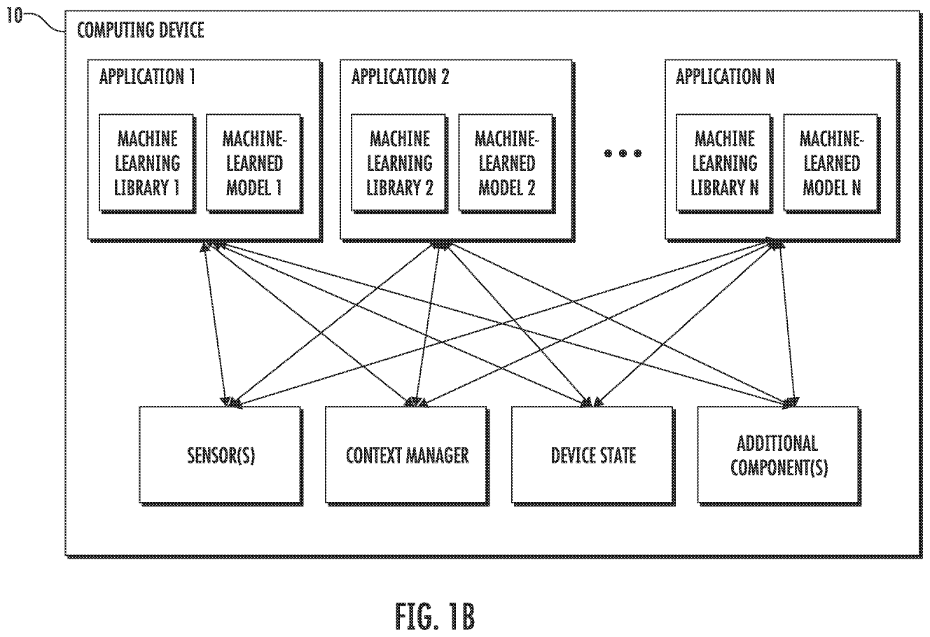

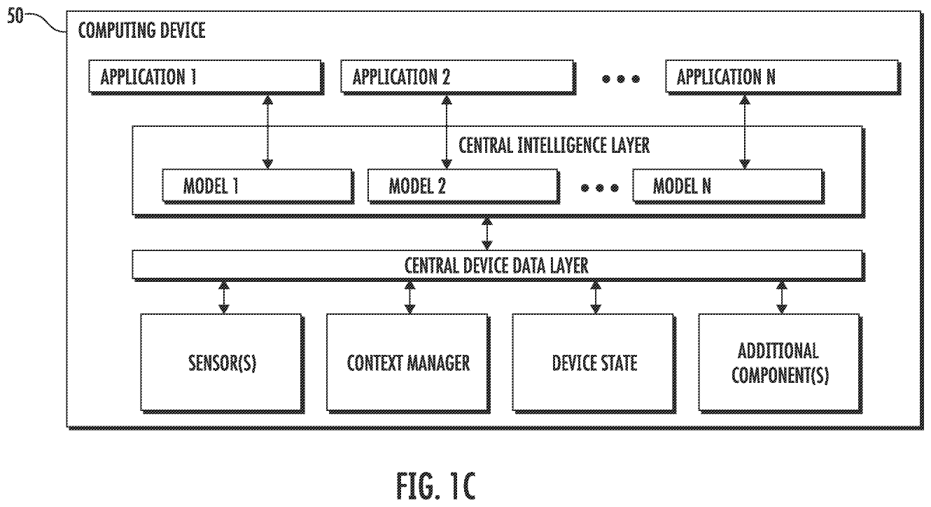

FIG. 1A depicts a block diagram of an example computing system 100 that performs view rendering (e.g., view rendering of low light and/or high contrast scenes) according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

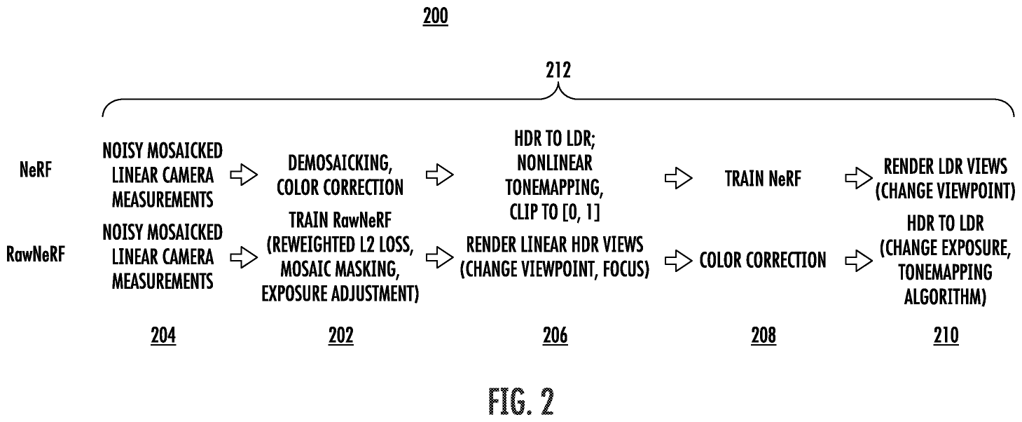

In some implementations, the user computing device 102 can store or include one or more neural radiance field models 120. For example, the neural radiance field models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example neural radiance field models 120 are discussed with reference to FIGS. 2-5.

In some implementations, the one or more neural radiance field models 120 can be received from the server computing system 130 over network 180, stored in the user computing device memory 114, and then used or otherwise implemented by the one or more processors 112. In some implementations, the user computing device 102 can implement multiple parallel instances of a single neural radiance field model 120 (e.g., to perform parallel view renderings across multiple instances of low light scenes).

More particularly, the systems and methods can include training a neural radiance field model on a plurality of raw noisy images (e.g., a plurality of unprocessed images) on a low light and/or high contrast scene. The trained neural radiance field model can then be utilized for generating view renderings for the low light and/or high contrast scenes.

Additionally or alternatively, one or more neural radiance field models 140 can be included in or otherwise stored and implemented by the server computing system 130 that communicates with the user computing device 102 according to a client-server relationship. For example, the neural radiance field models 140 can be implemented by the server computing system 140 as a portion of a web service (e.g., a view rendering service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned neural radiance field models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 2-5.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the neural radiance field models 120 and/or 140 based on a set of training data 162. The training data 162 can include, for example, a plurality of three-dimensional positions, a plurality of two-dimensional view directions, and a plurality of raw noisy images. Each of the plurality of raw noisy images may be associated with at least one position and at least one view direction.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data).

In some cases, the input includes visual data, and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

FIG. 2 depicts a block diagram of an example neural radiance field model 200 (e.g., RawNeRF) according to example embodiments of the present disclosure. In some implementations, the neural radiance field model 200 is trained to receive a set of input data 204 descriptive of a raw noisy image data (e.g., unprocessed images and their respective positions and view directions) and, as a result of receipt of the input data 204, provide output data 206 that can be evaluated against training data to determine a gradient descent to backpropagate to the neural radiance field model for training. Thus, in some implementations, the neural radiance field model 200 can include a RawNeRF model 202 that is operable to generate view renderings for low light scenes once trained. The output data 206 can include rendered linear views. The output data 206 can be processed with a color correction block 208 to generate a refined view rendering 210. The refined view rendering 210 can include a high dynamic range to low dynamic range conversion. Additionally and/or alternatively, the refined view rendering 210 can be generated based on an exposure change and/or tone-mapping determination.

The systems and methods of the present disclosure can differ from a low dynamic range neural radiance field pipeline 212. In particular, the low dynamic range neural radiance field pipeline 212 can include preprocessing the image data before training the neural radiance field model, which can train the neural radiance field model to output a view rendering that generalizes to the biases of the processed data. Alternatively and/or additionally, the systems and methods of the present disclosure can train the neural radiance field model 202 on input data 204 that includes raw noisy image data.

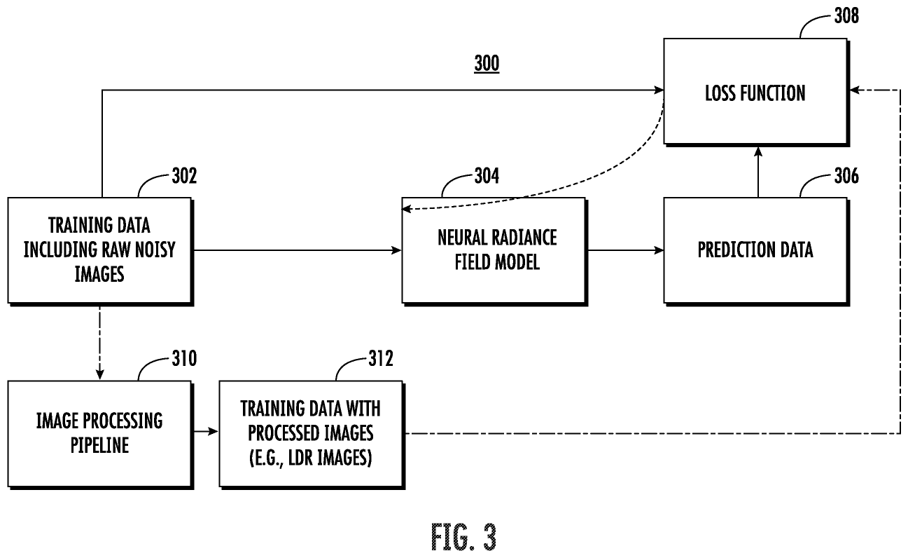

FIG. 3 depicts a block diagram of an example neural radiance field model 300 according to example embodiments of the present disclosure. The neural radiance field model 300 is similar to the neural radiance field model 200 of FIG. 2 except that the neural radiance field model 300 further includes the optional LDR pipeline in series with the HDR pipeline instead of displayed in parallel as depicted in FIG. 2.

In particular, training data 302 can include a plurality of raw noisy images, a plurality of two-dimensional view directions, and a plurality of three-dimensional positions. A two-dimensional view direction and a three-dimensional position can be processed with the neural radiance field model 304 to generate prediction data 306. The prediction data 306 can include one or more predicted density values and/or one or more predicted color values. The prediction data 306 can then be compared against ground truth data to evaluate a loss function 308.

For an LDR pipeline, the ground truth data can include processed image data. For example, a raw noisy image associated with the view direction and the position can be processed with an image processing pipeline 310 to generate training data with processed images 312. The prediction data 306 and the processed image can be utilized to evaluate a loss function 308. A gradient descent can then be backpropagated to the neural radiance field model 304 to adjust one or more parameters of the neural radiance field model 304.

Alternatively and/or additionally, for an HDR pipeline, the ground truth data can include a raw noisy image. For example, the prediction data 306 and a raw (unprocessed) noisy image can be utilized to evaluate the loss function 308 to generate a gradient descent, which can be backpropagated to the neural radiance field model 304 to adjust one or more parameters of the neural radiance field model 304.

Both the LDR pipeline and the HDR pipeline can include generating prediction data 306, which can be utilized to evaluate a loss function 308. However, the ground truth data and/or the loss function 308 can differ. In particular, the LDR pipeline can include processed image data as the ground truth, which can cause the neural radiance field model 304 to learn to output low dynamic range data. Alternatively and/or additionally, the HDR pipeline can include unprocessed image data as the ground truth, which can cause the neural radiance field model 304 to learn to output high dynamic range data.

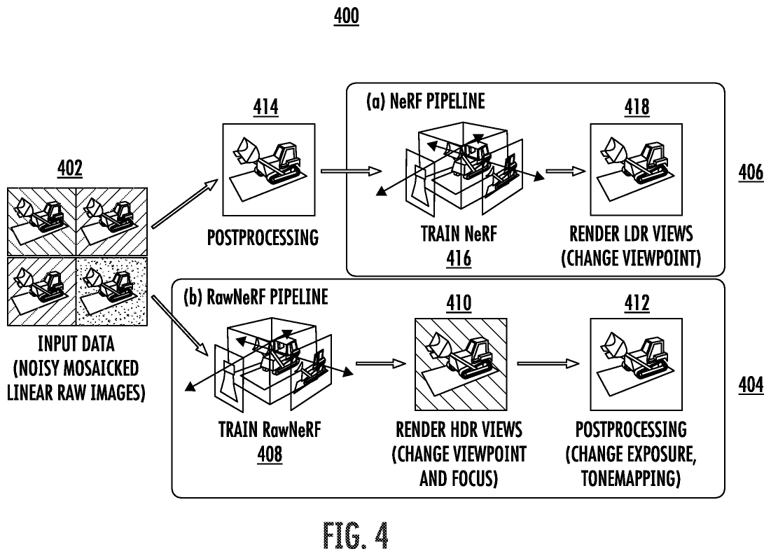

FIG. 4 depicts an illustration of an example view rendering pipeline 400 according to example embodiments of the present disclosure. For a low dynamic range neural radiance field model pipeline 406, input data 4002 (e.g., noisy mosaicked linear raw images (e.g., RGGB bayer filter image datasets)) can be processed 414 to demosaic the images and perform color and/or exposure correction. The resulting processed image data can then be utilized to train a neural radiance field model 416. The trained model can then be utilized to render low dynamic range views 418 of the environment that the neural radiance field model was trained on.

For a high dynamic range neural radiance field model pipeline 404, the input data 402 can be utilized to directly train the raw neural radiance field model 408. The trained model can be trained to render high dynamic range views 410 of the environment that the raw neural radiance field model is trained on. The rendered high dynamic range views 410 can then be post processed 412 to change the exposure and tone-mapping of the view rendering to generate a refined view rendering.

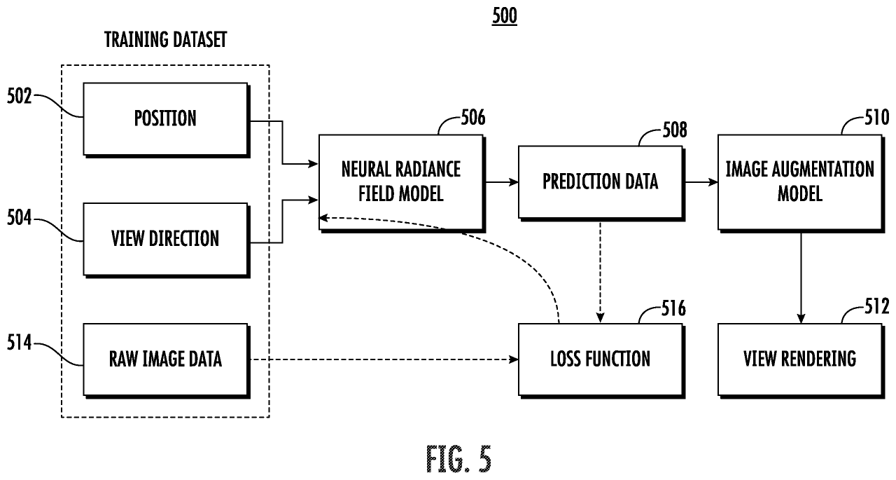

FIG. 5 depicts a block diagram of an example neural radiance field model training 500 according to example embodiments of the present disclosure. The neural radiance field model training 500 can include obtaining a training dataset. The training dataset can include one or more positions 502, one or more view directions, and/or one or more raw image datasets 514. For training, a three-dimensional position 502 and a two-dimensional view direction 504 can be processed with the neural radiance field model 506 to generate prediction data 508. The prediction data 508 can include one or more predicted color values and/or one or more predicted density values. The prediction data 508 and a raw image dataset 514 from the training dataset can be utilized to evaluate a loss function 516. The loss function 516 can then be utilized to adjust one or more parameters of the neural radiance field model 506.

Once the neural radiance field model 506 has been trained, a novel position and view direction set can be processed with the neural radiance field model 506 to generate prediction data 508, which can then be processed with an image augmentation model 510 to generate a novel view rendering 512. The novel view rendering 512 can be associated with processed image data.

### Example Methods

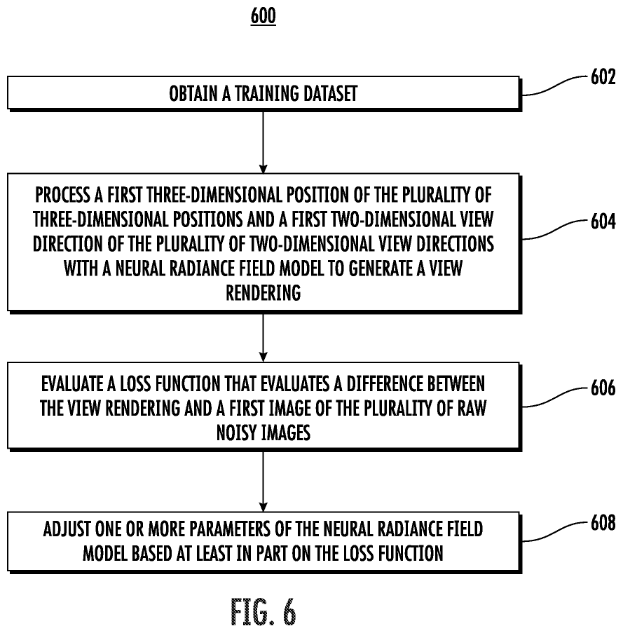

FIG. 6 depicts a flow chart diagram of an example method to perform according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can obtain a training dataset. The training dataset can include a plurality of three-dimensional positions, a plurality of two-dimensional view directions, and a plurality of raw noisy images. In some implementations, the plurality of raw noisy images can include a plurality of high dynamic range images including a plurality of unprocessed bits structured in a raw format. In some implementations, the plurality of raw noisy images can be associated with a plurality of red-green-green-blue datasets. In some implementations, the plurality of raw noisy images can include bayer filter datasets generated based on raw signal data from one or more image sensors. The raw noisy image datasets can include data before exposure correction, color correction, and/or focus correction. The plurality of two-dimensional view directions and the plurality of three-dimensional positions can be associated with view directions and positions in an environment. The environment can include low lighting, and the plurality of raw noisy images can include low lighting.

At 604, the computing system can process a first three-dimensional position of the plurality of three-dimensional positions and a first two-dimensional view direction of the plurality of two-dimensional view directions with a neural radiance field model to generate a view rendering. In some implementations, the neural radiance field model can include one or more multi-layer perceptrons. The view rendering can be descriptive of one or more predicted color values and one or more predicted volume density values. The neural radiance field model can be configured to process a view direction and a position to generate one or more predicted color values and one or more predicted density values. The one or more predicted color values and the one or more predicted density values can be utilized to generate the view rendering. The view rendering can be a raw view rendering associated with one or more bayer filter images associated with one or more red, blue, or green filters. The raw view rendering may be processed with one or more image augmentation blocks to generate an augmented image with one or more corrected colors, one or more corrected focuses, one or more corrected exposures, and/or one or more corrected artifacts.

At 606, the computing system can evaluate a loss function that evaluates a difference between the view rendering and a first image of the plurality of raw noisy images. The first image can be associated with at least one of the first three-dimensional position or the first two-dimensional view direction. In some implementations, the loss function can include a reweighted L2 loss. Evaluating the loss function that evaluates the difference between the view rendering and the first image of the plurality of raw noisy images can include mosaic masking. Alternatively and/or additionally, evaluating the loss function that evaluates the difference between the view rendering and the first image of the plurality of raw noisy images can include exposure adjustment. In some implementations, the first image can include a real-world photon signal data generated by a camera. The view rendering can include predicted photon signal data.

At 608, the computing system can adjust one or more parameters of the neural radiance field model based at least in part on the loss function. The loss function can include a stop gradient. In some implementations, the stop gradient can mitigate the neural radiance field model generalizing to low confidence values.

In some implementations, the computing system can process the view rendering with a color correction model to generate a color corrected rendering. Alternatively and/or additionally, the view rendering can be processed with an exposure correction model to generate an exposure corrected rendering. The color correction model and/or the exposure correction model can be part of an image augmentation block. The one or more image correction models can be configured to process raw signal data and/or predicted raw signal data. The one or more image correction models can be part of an image augmentation model and can be trained on bayer filter signal data.

Additionally and/or alternatively, the computing system can obtain an input view direction and an input position, processing the input view direction and the input position with the neural radiance field model to generate predicted quad bayer filter data, and processing the predicted quad bayer filter data to generate a novel view rendering.

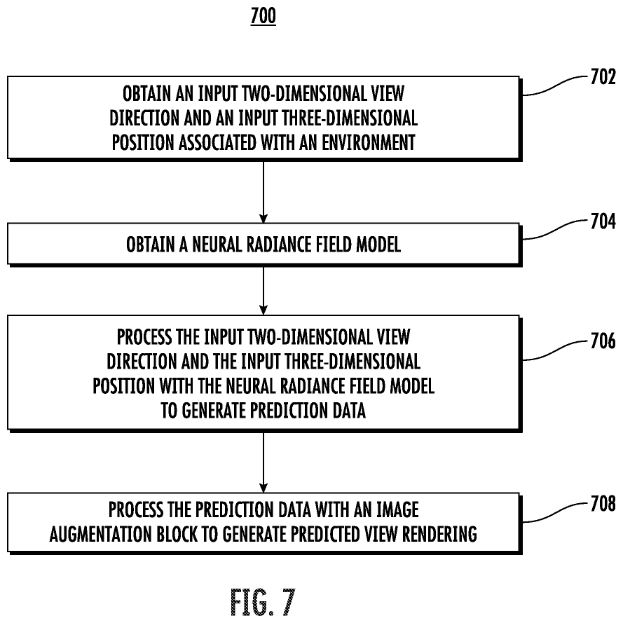

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain an input two-dimensional view direction and an input three-dimensional position associated with an environment. The environment can include one or more objects. In some implementations, the environment can include low lighting. The input view direction and the input three-dimensional position can be associated with a request for a novel view rendering that depicts a predicted view of the environment associated with the position and the view direction.

At 704, the computing system can obtain a neural radiance field model. The neural radiance field model may have been trained on a training dataset. The training dataset can include a plurality of noisy input datasets associated with the environment. In some implementations, the training dataset can include a plurality of training view directions and a plurality of training positions. Each noisy input dataset the plurality of noisy input datasets can include photon signal data. Additionally and/or alternatively, each noisy input dataset of the plurality of noisy input datasets can include signal data associated with at least one of a red value, a green value, or a blue value. In some implementations, each noisy input dataset the plurality of noisy input datasets can include one or more noisy mosaicked linear raw images.

At 706, the computing system can process the input two-dimensional view direction and the input three-dimensional position with the neural radiance field model to generate prediction data. The prediction data can include one or more predicted density values and one or more predicted color values. The prediction data can be utilized to generate predicted bayer filter data that can include predicted red filter data, predicted blue filter data, predicted first green filter data, and/or predicted second green filter data. The prediction data can be associated with predicted raw image data, which can be processed to generate refined image data.

At 708, the computing system can process the prediction data with an image augmentation block to generate predicted view rendering. The predicted view rendering can be descriptive of a predicted scene rendering of the environment. In some implementations, the image augmentation block can adjust a focus of the prediction data. Additionally and/or alternatively, the image augmentation block can adjust an exposure level of the prediction data. The image augmentation block can adjust a tone-mapping of the prediction data.

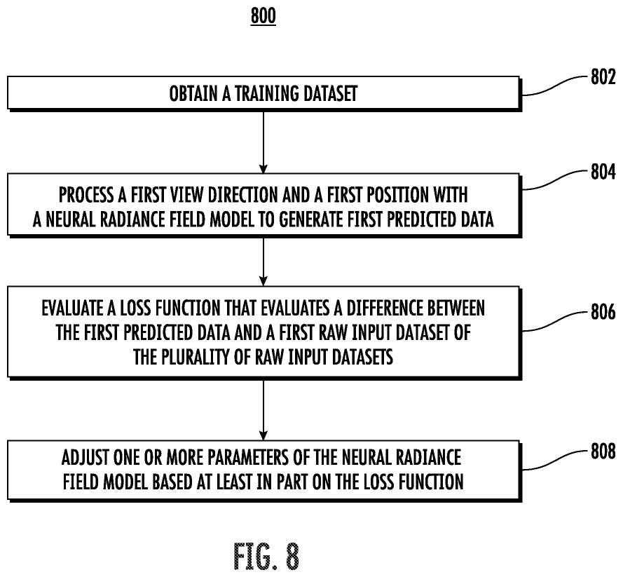

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain a training dataset. The training dataset can include a plurality of raw input datasets. In some implementations, the training dataset can include a plurality of respective view directions and a plurality of respective positions. The plurality of respective view directions can include a plurality of two-dimensional view directions. The plurality of respective positions can include a plurality of three-dimensional positions. The raw input datasets can include one or more high dynamic range images.

At 804, the computing system can process a first view direction and a first position with a neural radiance field model to generate first predicted data. The first predicted data can be descriptive of one or more first predicted color values and one or more first predicted density values. The first predicted data can be associated with predicted raw photon signal data.

At 806, the computing system can evaluate a loss function that evaluates a difference between the first predicted data and a first raw input dataset of the plurality of raw input datasets. The first raw input dataset can be associated with at least one of the first position or the first view direction. In some implementations, the loss function can include a tone-mapping loss associated with processing at least one of the first predicted data or the first raw input dataset. The loss function can penalize errors in dark regions more heavily than light regions in order to align with how human perception compresses dynamic range. The penalization can occur after both the first prediction data and the first raw input dataset are passed through a tone-mapping curve before loss function evaluation. In some implementations, the loss function can include a weighted loss function. The loss may be applied to the active color channels of a mosaiced raw input data and/or the first predicted data. Additionally and/or alternatively, camera intrinsics can be utilized to account for radial distortions when generating rays.

At 808, the computing system can adjust one or more parameters of the neural radiance field model based at least in part on the loss function. The one or more parameters can be associated with a learned three-dimensional representation associated with an environment. In some implementations, the one or more parameters can be adjusted to learn the environment.

In some implementations, the systems and methods can include training the neural radiance field model on an environment using image data generated using differing shutter speeds. For example, the systems and methods can include processing a second view direction and a second position with the neural radiance field model to generate second predicted data. The second predicted data can be descriptive of one or more second predicted color values and one or more second predicted density values. The systems and methods can include scaling the one or more second predicted color values based on a shutter speed to generate scaled second predicted data. The loss function that evaluates the difference between the scaled second predicted data and a second raw input dataset of the plurality of raw input datasets can then be evaluated. The second raw input dataset can be associated with at least one of the second position or the second view direction. One or more additional parameters of the neural radiance field model can be adjusted based at least in part on the loss function.

### Example Implementations

Neural Radiance Fields (NeRF) can be utilized for high quality novel view synthesis from a collection of posed input images. NeRF can use tone-mapped low dynamic range (LDR) as input. The images may have been processed by a lossy camera pipeline that smooths detail, clips highlights, and distorts the simple noise distribution of raw sensor data. The systems and methods disclosed herein can include a modified NeRF to train directly on linear raw images, preserving the scene's full dynamic range. By rendering raw output images from the resulting NeRF, the systems and methods can perform novel high dynamic range (HDR) view synthesis tasks. In addition to changing the camera viewpoint, the systems and methods can manipulate focus, exposure, and tone-mapping after the fact. Although a single raw image appears significantly noisier than a post processed one, the systems and methods can show that NeRF is highly robust to the zero-mean distribution of raw noise. When optimized over many noisy raw inputs (e.g., 25-200), NeRF can produce an accurate scene representation that renders novel views that outperform dedicated single and multi-image deep raw denoisers run on the same wide baseline input images. In some implementations, the systems and methods can reconstruct scenes from extremely noisy images captured in near darkness.

View synthesis methods (e.g., neural radiance fields (NeRF)) can utilize tone-mapped low dynamic range (LDR) images as input and directly reconstruct and render new views of a scene in LDR space. Inputs for scenes that are well-lit and do not contain large brightness variations may be captured with minimal noise using a single fixed camera exposure setting. However, images taken at nighttime or in any but the brightest indoor spaces may have poor signal-to-noise ratios, and scenes with regions of both daylight and shadow may have extreme contrast ratios that may rely on high dynamic range (HDR) to represent accurately.

The systems and methods (e.g., systems and methods including RawNeRF) can modify NeRF to reconstruct the scene in linear HDR color space by supervising directly on noisy raw input images. The modification can bypass the lossy post processing that cameras apply to compress dynamic range and smooth out noise in order to produce visually palatable 8-bit JPEGs. By preserving the full dynamic range of the raw inputs, the systems and methods (e.g., systems and methods including RawNeRF) can enable various novel HDR view synthesis tasks. The systems and methods can modify the exposure level and tone-mapping algorithm applied to rendered outputs and can create synthetically refocused images with accurately rendered bokeh effects around out-of-focus light sources.

Beyond the view synthesis applications, the systems and methods can show that training directly on raw data effectively turns RawNeRF into a multi-image denoiser capable of reconstructing scenes captured in near darkness. A camera post processing pipeline (e.g., HDR+) may corrupt the simple noise distribution of raw data, introducing significant bias in order to reduce variance and produce an acceptable output image. Feeding the images into NeRF can thus produce a biased reconstruction with incorrect colors, particularly in the darkest regions of the scene. The systems and methods can utilize NeRF's ability to reduce variance by aggregating information across frames, demonstrating that processing may be possible for RawNeRF to produce a clean reconstruction from many noisy raw inputs.

The systems and methods disclosed herein can assume a static scene and expects camera poses as input. Provided with the extra constraints, the systems and methods can be able to make use of three-dimensional multi-view consistency to average information across nearly all of the input frames at once. In some implementations, the captured scenes can each contain 25-200 input images, which can mean the systems and methods can remove more noise than feed-forward single or multi-image denoising networks that make use of 1-5 input images for each output.

The systems and methods can include training a neural radiance field model directly on raw images that can handle high dynamic range scenes as well as noisy inputs captured in the dark. The systems and methods may outperform NeRF on noisy real and synthetic datasets and can be a competitive multi-image denoiser for wide-baseline static scenes. The systems and methods can perform novel view synthesis applications by utilizing a linear HDR scene representation (e.g., a representation, which can include data descriptive of varying exposure, tone-mapping, and focus).

The systems and methods (e.g., the systems and methods that include RawNeRF) can include NeRF as a baseline for high quality view synthesis, can utilize low level image processing to optimize NeRF directly on noisy raw data, and can utilize HDR in computer graphics and computational photography to showcase new applications made possible by an HDR scene reconstruction.

Novel view synthesis can use a set of input images and their camera poses to reconstruct a scene representation capable of rendering novel views. When the input images are densely sampled, the systems and methods can use direct interpolation in pixel space for view synthesis.

In some implementations, view synthesis may include learning a volumetric representation rather than mesh-based scene representations. A NeRF system may directly optimize a neural volumetric scene representation to match all input images using gradient descent on a rendering loss. Various extensions may be utilized to improve NeRF's robustness to varying lighting conditions, and/or supervision may be added with depth, time-of-flight data, and/or semantic segmentation labels. In some implementations, view synthesis methods can be trained using LDR data jointly to solve for per-image scaling factors to account for inconsistent lighting or miscalibration between cameras. In some implementations, the systems and methods can include supervising with LDR images and can solve for exposure through a differentiable tone-mapping step to approximately recover HDR but may not focus on robustness to noise or supervision with raw data. The systems and methods may include denoising sRGB images synthetically corrupted with additive white Gaussian noise.

The systems and methods disclosed herein can leverage preservation of dynamic range, which can allow for maximum post processing flexibility, letting users modify exposure, white balance, and tone-mapping after the fact.

When capturing an image, the number of photons hitting a pixel on the camera sensor can be converted to an electrical charge, which can be recorded as a high bit-depth digital signal (e.g., 10 to 14 bits). The values may be offset by a “black level” to allow for negative measurements due to noise. After black level subtraction, the signal may be a noisy measurement yᵢ of a quantity xᵢ proportional to the expected number of photons arriving while the shutter is open. The noise results from both the physical fact that photon arrivals can be a Poisson process (“shot” noise) and noise in the readout circuitry that converts the analog electrical signal to a digital value (“read” noise). The combined shot and read noise distribution can be well modeled as a Gaussian whose variance is an affine function of its mean, which can imply that the distribution of the error yᵢ−xᵢ is zero mean.

Color cameras can include a Bayer color filter array in front of the image sensor such that each pixel's spectral response curve measures either red, green, or blue light. The pixel color values may be typically arranged in 2×2 squares containing two green pixels, one red, and one blue pixel (e.g., a Bayer pattern), resulting in “mosaicked” data. To generate a full-resolution color image, the missing color channels may be interpolated using a demosaicing algorithm. The interpolation can correlate noise spatially, and the checkerboard pattern of the mosaic can lead to different noise levels in alternating pixels.

The spectral response curves for each color filter element may vary between different cameras, and a color correction matrix can be used to convert the image from this camera-specific color space to a standardized color space. Additionally and/or alternatively, because human perception can be robust to the color tint imparted by different light sources, cameras may attempt to account for the tint (e.g., make white surfaces appear RGB-neutral white) by scaling each color channel by an estimated white balance coefficient. The two steps can be typically combined into a single linear 3×3 matrix transform, which can further correlate the noise between color channels.

Humans may be able to discern smaller relative differences in dark regions compared to bright regions of an image. The fact can be exploited by sRGB gamma compression, which may optimize the final image encoding by clipping values outside [0,1] and may apply a nonlinear curve to the signal that dedicates more bits to dark regions at the cost of compressing bright highlights. In addition to gamma compression, tone-mapping algorithms can be used to better preserve contrast in high dynamic range scenes (where the bright regions are several orders of magnitude brighter than the darkest) when the image is quantized to 8 bits.

Tone-mapping can include the process by which linear HDR values are mapped to nonlinear LDR space for visualization. Signals before tone-mapping can be referred to as high dynamic range (HDR), and signals after may be referred to as low dynamic range (LDR). Of all post processing operations, tone-mapping may affect the noise distribution such that clipping completely discards information in the brightest and darkest regions, and after the non-linear tone-mapping curve the noise is no longer guaranteed to be Gaussian or even zero mean.

A neural radiance field (NeRF) model can include a neural network based scene representation that is optimized to reproduce the appearance of a set of input images with known camera poses. The resulting reconstruction can then be used to render novel views from previously unobserved poses. NeRF's multilayer perceptron (MLP) network can obtain a three-dimensional position and two-dimensional viewing direction as input and can output volume density and color. To render each pixel in an output image, NeRF can use volume rendering to combine the colors and densities from many points sampled along the corresponding three-dimensional ray.

Standard NeRF can obtain clean, low dynamic range (LDR) sRGB color space images with values in the range [0,1] as input. Converting raw HDR images to LDR images can include two consequences: (1) Detail in bright areas can be lost when values are clipped from above at one, and detail across the image is compressed by the tone-mapping curve and subsequent quantization to 8 bits, and (2) The per-pixel noise distribution can become biased (no longer zero-mean) after passing through a nonlinear tone-mapping curve and being clipped from below at zero.

The systems and methods disclosed herein can optimize NeRF directly on linear raw input data in HDR color space. The systems and methods can show that reconstructing NeRF in raw space can be much more robust to noisy inputs and allows for novel HDR view synthesis applications.

Since the color distribution in an HDR image can span many orders of magnitude, a standard L2 loss applied in HDR space will be completely dominated by error in bright areas and can produce an image that has muddy dark regions with low contrast when tone-mapped. The systems and methods can apply a loss that more strongly penalizes errors in dark regions to align with how human perception compresses dynamic range. One way to achieve the result can be by passing both the rendered estimate ŷ and noisy observed intensity y through a tone-mapping curve ψ before the loss is applied:

$${L}_{ψ} ( \hat{y} , y ) = {\sum }_{i} {( ψ ( {\hat{y}}_{i} ) - ψ ( {y}_{i} ) )}^{2} . \qquad ( 1 )$$

In some implementations, in low-light raw images the observed signal y can be heavily corrupted by zero-mean noise, and a nonlinear tone-map can introduce bias that changes the noisy signal's expected value (E[ψ(y)]≠ψ(E[y])). In order for the network to converge to an unbiased result, the systems and methods may use a weighted L2 loss of the form

$$L ( \hat{y} , y ) = {\sum }_{i} {w}_{i} {( {\hat{y}}_{i} - {y}_{i} )}^{2} . \qquad ( 2 )$$

The systems and methods can approximate the tone-mapped loss (1) in this form by using a linearization of the tone curve ψ around each ŷᵢ:

$${\tilde{L}}_{ψ} ( \hat{y} , y ) = {\sum }_{i} {[ {ψ}^{′} ( sg ( {\hat{y}}_{i} ) ) ( ( {\hat{y}}_{i} - {y}_{i} ) ]}^{2} , \qquad ( 3 )$$

where sg(·) may indicate a stop-gradient that treats the argument as a constant with zero derivative, preventing the result from influencing the loss gradient during backpropagation.

A “gradient supervision” tone curve ψ(z)=log(y+ε) with ε=10⁻³ can produce perceptually high quality results with minimal artifacts, which can imply a loss weighting term of ψ′(sg(ŷᵢ))=(sg(ŷᵢ)+ε)⁻¹ and final loss

$${\tilde{L}}_{ψ} ( \hat{y} , y ) = {\sum }_{i} {( \frac{{\hat{y}}_{i} - {y}_{i}}{sg ( {\hat{y}}_{i} ) + ε} )}^{2} . \qquad ( 4 )$$

The result can correspond exactly to the relative MSE loss used to achieve unbiased results when training on noisy HDR path-tracing data in Noise2Noise. The curve ψ can be proportional to the μ-law function used for range compression in audio processing, and may have been applied as a tone-mapping function when supervising a network to map from a burst of LDR images to an HDR output.

In some implementations, the systems and methods can include variable exposure training. In scenes with very high dynamic range (e.g., a 10-14 bit raw image) may not be sufficient for capturing both bright and dark regions in a single exposure. The systems and methods can address the potential issue by the “bracketing” mode included in many digital cameras, where multiple images with varying shutter speeds are captured in a burst, then merged to take advantage of the bright highlights preserved in the shorter exposures and the darker regions captured with more detail in the faster exposures.

The systems and methods can leverage variable exposures in RawNeRF. Given a sequence of images Iᵢ with exposure times tᵢ (and all other capture parameters held constant), the systems and methods can “expose” RawNeRF's linear space color output to match the brightness in image Iᵢ by scaling it by the recorded shutter speed tᵢ. Varying exposures may not be precisely aligned using shutter speed alone due to sensor miscalibration. The systems and methods may add a learned per-color-channel scaling factor for each unique shutter speed present in the set of captured images, which can jointly optimize along with the NeRF network. The final RawNeRF “exposure” given a output color ŷᵢ from the network can then be min(ŷᵢ^{c}·tᵢ·αₜ_{ᵢ}^{c}, 1), where c indexes color channels, and αₜ_{ᵢ}^{c} is the learned scaling factor for shutter speed tᵢ and channel c (we constrain αₜ_{ₘₐₓ}^{c}=1 for the longest exposure). The systems and methods may clip from above at 1 to account for the fact that pixels saturate in overexposed regions. The scaled and clipped value can be passed to the previously described loss (Equation 4).

The systems and methods disclosed herein may utilize the mip-NeRF codebase, which can improve upon the positional encoding used in the original NeRF method. Please see that paper for further details on the MLP scene representation and volumetric rendering algorithm. The network architecture can include a change that modifies the activation function for the MLP's output color from a sigmoid to an exponential function to better parameterize linear radiance values. The systems and methods can utilize the Adam optimizer with batches of 16k random rays sampled across all training images and a learning rate decaying from 10⁻³ to 10⁻⁵ over 500k steps of optimization.

Extremely noisy scenes may benefit from a regularization loss on volume density to prevent partially transparent “floater” artifacts. For example, the systems and methods may apply a loss on the variance of the weight distribution used to accumulate color values along the ray during volume rendering.

As the raw input data is mosaicked, the raw input data may include one color value per pixel. The systems and methods may apply the loss to the active color channel for each pixel, such that optimizing NeRF effectively demosaics the input images. Since any resampling steps may affect the raw noise distribution, the systems and methods may not undistort or downsample the inputs, and instead may train using the full resolution mosaicked images (e.g., 12MP for the scenes). In some implementations, the systems and methods may utilize camera intrinsics to account for radial distortion when generating rays. The systems and methods may utilize full resolution post processed JPEG images to calculate camera poses.

The systems and methods disclosed herein can be robust to high levels of noise, to the extent that the system can act as a competitive multi-image denoiser when applied to wide-baseline images of a static scene. Additionally and/or alternatively, the systems and methods can utilize HDR view synthesis applications enabled by recovering a scene representation to preserve high dynamic range color values.

Deep learning methods for denoising images directly in the raw linear domain can include multi-image denoisers that can be applied to burst images or video frames. These multi-image denoisers can assume that there is a relatively small amount of motion between frames, but that there may be large amounts of object motion within the scene. When nearby frames can be well aligned, the methods can merge information from similar image patches (e.g., across 2-8 neighboring images) to outperform single image denoisers.

NeRF can optimize for a single scene reconstruction that is consistent with the input images. By specializing to wide-baseline static scenes and taking advantage of 3D multi-view information, RawNeRF can aggregate observations from much more widely spaced input images than a typical multi-image denoising method.

For testing the system, the systems and methods can obtain a real world denoising dataset with 3 different scenes, each including 101 noisy images and a clean reference image merged from stabilized long exposures. The first 100 images can be taken handheld across a wide baseline (e.g., a standard forward-facing NeRF capture), using a fast shutter speed to accentuate noise. The systems and methods can then capture a stabilized burst of 50-100 longer exposures on a tripod and robustly merge them using HDR+ to create a clean ground truth frame. One additional tripod image taken at the original fast shutter speed can serve as a noisy input “base frame” for the deep denoising methods. All images may be taken with a mobile device at 12MP resolution using the wide-angle lens and saved as 12-bit raw DNG files.

In some implementations, the systems and methods disclosed herein can RawNeRF can utilize just a camera pose, while other techniques may rely on the denoisers receiving the noisy test image.

Given a full 3D model of a scene, physically-based renderers can accurately simulate camera lens defocus effects by tracing rays refracted through each lens element, and the process can be extremely computationally expensive. In some implementations, the systems and methods can apply a varying blur kernel to different depth layers of the scene and composite them together. The systems and methods can apply the synthetic defocus rendering model to sets of RGBA depth layers precomputed from trained RawNeRF models (similar to a multiplane image). Recovering linear HDR color can be critical for achieving the characteristic oversaturated “bokeh balls” around defocused bright light sources.

Training the neural radiance field model can include a gradient-weighted loss. For example, the systems and methods can approximate the effect of training with the following loss

$${L}_{ψ} ( \hat{y} , y ) = {\sum }_{i} {( ψ ( {\hat{y}}_{i} ) - ψ ( {y}_{i} ) )}^{2} \qquad ( 5 )$$

while converging to an unbiased result. The results can be accomplished by using a locally valid linear approximation for the error term:

$$ψ ( {\hat{y}}_{i} ) - ψ ( {y}_{i} ) \approx ψ ( {\hat{y}}_{i} ) - ( ψ ( {\hat{y}}_{i} ) + {ψ}^{′} ( {\hat{y}}_{i} ) ( {y}_{i} - {\hat{y}}_{i} ) = {ψ}^{′} ( {\hat{y}}_{i} ) ( {\hat{y}}_{i} - {y}_{i} ) . \qquad ( 6 )$$

The systems and methods can choose to linearize around ŷᵢ because, the noisy observation yᵢ, ŷᵢ tends towards the true signal value xᵢ=E[yᵢ] over the course of training.

If a weighted L2 loss is used, then as the system is trained the network can have ŷᵢ→E[yᵢ]=xᵢ in expectation (where xᵢ is the true signal value). Therefore, the terms can be summed in the gradient-weighted loss:

$${\tilde{L}}_{ψ} ( \hat{y} , y ) = {\sum }_{i} {[ {ψ}^{′} ( sg ( {\hat{y}}_{i} ) ) ( {\hat{y}}_{i} - {y}_{i} ) ]}^{2} \qquad ( 7 )$$

which can tend towards ψ′(xᵢ)(yᵢ−yᵢ) over the course of training. Additionally and/or alternatively, the gradient of the reweighted loss 7 can be a linear approximation of the gradient of the tone-mapped loss 5:

$${∇}_{θ} {L}_{ψ} ( \hat{y} , y ) = {\sum }_{i} {∇}_{θ} {( ψ ( {\hat{y}}_{i} ) - ψ ( {y}_{i} ) )}^{2} \qquad ( 8 )$$

$$= {\sum }_{i} 2 ( ψ ( {\hat{y}}_{i} ) - ψ ( {y}_{i} ) ) {ψ}^{′} ( {\hat{y}}_{i} ) {∇}_{θ} {y}_{i} \qquad ( 9 )$$

$$\approx {\sum }_{i} 2 ( {ψ}^{′} ( {\hat{y}}_{i} ) ( {\hat{y}}_{i} - {y}_{i} ) ) {ψ}^{′} ( {\hat{y}}_{i} ) {∇}_{θ} {y}_{i} \qquad ( 10 )$$

$$= {\sum }_{i} 2 ( {ψ}^{′} ( sg ( {\hat{y}}_{i} ) ) ( {\hat{y}}_{i} - {y}_{i} ) ) {ψ}^{′} ( sg ( {\hat{y}}_{i} ) ) {∇}_{θ} {y}_{i} \qquad ( 11 )$$

$$= {∇}_{θ} {\tilde{L}}_{ψ} ( \hat{y} , y ) . \qquad ( 12 )$$

In equation 10, the linearization from 6 can be substituted, and in equation 11, the systems and methods can exploit the fact that a stop-gradient has no effect for expressions that will not be further differentiated.

Additionally and/or alternatively, training can include the use of a weight variance regularizer. The weight variance regularizer can be a function of the compositing weights used to calculate the final color for each ray. Given MLP outputs cᵢ, σᵢ for respective ray segments [tᵢ₋₁, tᵢ) with lengths Δᵢ (see [3]), the weights can be

$${w}_{i} = ( 1 - exp ( - {Δ}_{i} {σ}_{i} ) ) exp ( - {\sum }_{j < i} {Δ}_{j} {σ}_{j} ) . \qquad ( 13 )$$

If a piecewise-constant probability distribution p_{w} is defined over the ray segments using the weights, then the variance regularizer can be equal to

$${ℒ}_{w} = {Var}_{X ∼ {p}_{w}} ( X ) = {E}_{X ∼ {p}_{W}} [ {( X - E [ X ] )}^{2} ] \qquad ( 14 )$$

Calculating the mean (expected depth):

$${E}_{X ∼ {p}_{W}} [ X ] = {\sum }_{i} {\int }_{{t}_{i - 1}}^{{t}_{i}} \frac{{w}_{i}}{{Δ}_{i}} t dt \qquad ( 15 )$$

$$= {\sum }_{i} \frac{{w}_{i}}{{Δ}_{i}} \frac{{t}_{i}^{2} - {t}_{i - 1}^{2}}{2} \qquad ( 16 )$$

$$= {\sum }_{i} {w}_{i} \frac{{t}_{i} + {t}_{i - 1}}{2} . \qquad ( 17 )$$

The value can be denoted as t̅. Calculating the regularizer:

$${Var}_{X ∼ {p}_{w}} ( X ) = {E}_{X ∼ {p}_{W}} [ {( X - E [ X ] )}^{2} ] \qquad ( 18 )$$

$$= {\sum }_{i} {\int }_{{t}_{i - 1}}^{{t}_{i}} \frac{{w}_{i}}{{Δ}_{i}} {( t - \overline{t} )}^{2} dt \qquad ( 19 )$$

$$= {\sum }_{i} \frac{{w}_{i}}{{Δ}_{i}} \frac{{( {t}_{i} - \overline{t} )}^{3} - ( {( {t}_{i - 1} - \overline{t} )}^{3}}{3} \qquad ( 20 )$$

$$= {\sum }_{i} {w}_{i} \frac{{( {t}_{i} - \overline{t} )}^{2} + ( {t}_{i} - \overline{t} ) ( {t}_{i - 1} - \overline{t} ) + {( {t}_{i - 1} - \overline{t} )}^{2}}{3} \qquad ( 21 )$$

In some implementations, the systems and methods can apply a weight between 1×10⁻² and 1×10⁻¹ to [symbol] _{w} (relative to the rendering loss) (e.g., using higher weights in noisier or darker scenes that are more prone to “floater” artifacts). Applying the regularizer with a high weight can result in a minor loss of sharpness, which can be ameliorated by annealing its weight from 0 to 1 over the course of training.

The systems and methods may include scaling the loss by the derivative of the desired tone curve:

$${ψ}^{′} ( sg ( {\hat{y}}_{i} ) ) = \frac{1}{sg ( {\hat{y}}_{i} ) + ε} \qquad ( 22 )$$

The systems and methods can perform a hyperparameter sweep over loss weightings of the form (sg(ŷᵢ)+ε)^{-p} for ε and p and found that ε=1×10⁻³ and p=1 produced the best qualitative results.

In some implementations, the systems and methods may utilize a reweighted L1 loss or the negative log-likelihood function of the actual camera noise model (using shot/read noise parameters from the EXIF data). Alternatively and/or additionally, RawNeRF models supervised with a standard unweighted L2 or L1 loss may tend to diverge early in training, particularly in very noisy scenes.

The systems and methods may utilize the unclipped sRGB gamma curve (extended as a linear function below zero and as an exponential function above 1) in the loss. Directly applying the log tone curve (rather than reweighting by its gradient) before the L2 loss can cause training to diverge.

The color correction matrix C_{ccm} can be an XYZ-to-camera-RGB transform under the D65 illuminant, which can use the corresponding RGB-to-XYZ matrix:

$${C}_{rgb - xyz} = [ \begin{matrix}0.4 \; 124564 & 0.3575761 & 0.1804375 \\ 0.2126729 & 0.7151522 & 0.072175 \\ 0.0193339 & 0.119192 & 0.9503041\end{matrix} ] \qquad ( 23 )$$

The systems and methods may use these to create a single color transform Cₐₗₗ mapping from camera RGB directly to standard linear RGB space:

$${C}_{all} = rownorm ( {( {C}_{rgb - xyz} {C}_{ccm} )}^{- 1} ) \qquad ( 24 )$$

where rownorm normalizes each to sum to 1.

The systems and methods can use the standard sRGB gamma curve as a basic tone-map for linear RGB space data:

$${γ}_{sRGB} ( z ) = ( \begin{matrix}12.9 2 z & z \leq 0.0031308 \\ 1.05 5 {z}^{1 / 2.4} - 0.055 & z > 0.0031308\end{matrix} \qquad ( 25 )$$

To minimize the effect of image noise, the systems and methods can determine the average color value yₜ_{ᵢ}^{c} for each Bayer filter channel (R, G1, G2, B) over an entire 12MP sensor. For example, the systems and methods can plot:

$$\frac{{y}_{{t}_{i}}^{c}}{{t}_{i}} . \frac{{t}_{max}}{{y}_{{t}_{max}}^{c}} \qquad ( 32 )$$

which is the ratio of normalized brightness at speed tᵢ to normalized brightness at the longest shutter speed tₘₐₓ. In the case of perfect calibration, the plot may be equal to 1 everywhere since dividing out by shutter speed should perfectly normalize the brightness value. However, the quantity may decay for faster shutter speeds, the quantity may decay at different rates per color channel. In some implementations, a DSLR or mirrorless camera with a better sensor may be utilized.

The systems and methods can solve for an affine color alignment between each output and the ground truth clean image. For all methods but SID and LDR NeRF, the method can be performed directly in raw Bayer space for each RGGB plane separately. For SID and LDR NeRF (which output images in tone-mapped sRGB space), the method can be performed for each RGB plane against the tone-mapped sRGB clean image. If the ground truth channel is x and the channel to be matched is y, the systems and methods can compute

$$a = \frac{\overline{xy} - \overline{xy}}{\overline{{x}^{2}} - {\overline{x}}^{2}} = \frac{Cov ( xy )}{Var ( x )} , \qquad ( 33 )$$

$$b = \overline{y} - a \overline{x} \qquad ( 34 )$$

to get the least-squares fit of an affine transform ax+b≈y (here z̅ indicates the mean over all elements of z). The systems and methods can then apply the inverse transform as (y−b)/a to match the estimated y to x. In some implementations where matching happens in the raw domain, the systems and methods can postprocess (y−b)/a through our standard pipeline before calculating sRGB-space metrics.

To render defocused images, the systems and methods can utilize a specific synthetic defocus rendering model for particular tasks. To avoid prohibitively expensive rendering speeds, the systems and methods can first precompute a multiplane image representation from the trained neural radiance field model. The MPI can include a series of fronto-parallel RGBA planes (with colors still in linear HDR space), sampled linearly in disparity within a camera frustum at a central camera pose.

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing system, the system comprising:
one or more processors; and
one or more non-transitory computer-readable media that collectively store instructions that, when executed by the one or more processors, cause the computing system to perform operations, the operations comprising:
obtaining a training dataset, wherein the training dataset comprises a plurality of three-dimensional positions, a plurality of two-dimensional view directions, and a plurality of raw noisy images, wherein the plurality of raw noisy images comprise a plurality of high dynamic range images comprising a plurality of unprocessed bits structured in a raw format;
processing a first three-dimensional position of the plurality of three-dimensional positions and a first two-dimensional view direction of the plurality of two-dimensional view directions with a neural radiance field model to generate a view rendering, wherein the neural radiance field model comprises one or more multi-layer perceptrons, and wherein the view rendering is descriptive of one or more predicted color values and one or more predicted volume density values;
evaluating a loss function that evaluates a difference between the view rendering and a first image of the plurality of raw noisy images, wherein the first image is associated with at least one of the first three-dimensional position or the first two-dimensional view direction; and
adjusting one or more parameters of the neural radiance field model based at least in part on the loss function.

2. The computing system of claim 1, wherein the operations further comprise:
processing the view rendering with a color correction model to generate a color corrected rendering.

3. The computing system of claim 1, wherein the loss function comprises a reweighted L2 loss.

4. The computing system of claim 1, wherein evaluating the loss function that evaluates the difference between the view rendering and the first image of the plurality of raw noisy images comprises mosaic masking.

5. The computing system of claim 1, wherein evaluating the loss function that evaluates the difference between the view rendering and the first image of the plurality of raw noisy images comprises exposure adjustment.

6. The computing system of claim 1, wherein the operations further comprising:
obtaining an input view direction and an input position;
processing the input view direction and the input position with the neural radiance field model to generate predicted quad bayer filter data; and
processing the predicted quad bayer filter data to generate a novel view rendering.

7. The computing system of claim 1, wherein the loss function comprises a stop gradient, wherein the stop gradient mitigates the neural radiance field model generalizing to low confidence values.

8. The computing system of claim 1, wherein the first image comprises a real-world photon signal data generated by a camera, and wherein the view rendering comprises predicted photon signal data.

9. The computing system of claim 1, wherein the plurality of raw noisy images are associated with a plurality of red-green-green-blue datasets.

10. A computer-implemented method for novel view rendering, the method comprising:
obtaining, by a computing system comprising one or more processors, an input two-dimensional view direction and an input three-dimensional position associated with an environment;
obtaining, by the computing system, a neural radiance field model, wherein the neural radiance field model was trained on a training dataset, wherein the training dataset comprises a plurality of noisy input datasets associated with the environment, wherein the training dataset comprises a plurality of training view directions and a plurality of training positions;
processing, by the computing system, the input two-dimensional view direction and the input three-dimensional position with the neural radiance field model to generate prediction data, wherein the prediction data comprises one or more predicted density values and one or more predicted color values;
processing, by the computing system, the prediction data with an image augmentation block to generate predicted view rendering, wherein the predicted view rendering is descriptive of a predicted scene rendering of the environment.

11. The method of claim 10, wherein the image augmentation block adjusts a focus of the prediction data.

12. The method of claim 10, wherein the image augmentation block adjusts an exposure level of the prediction data.

13. The method of claim 10, wherein the image augmentation block adjusts a tone-mapping of the prediction data.

14. The method of claim 10, wherein each noisy input dataset the plurality of noisy input datasets comprises photon signal data.

15. The method of claim 10, wherein each noisy input dataset the plurality of noisy input datasets comprises signal data associated with at least one of a red value, a green value, or a blue value.

16. The method of claim 10, wherein each noisy input dataset the plurality of noisy input datasets comprises one or more noisy mosaicked linear raw images.

17. One or more non-transitory computer-readable media that collectively store instructions that, when executed by one or more computing devices, cause the one or more computing devices to perform operations, the operations comprising:
obtaining a training dataset, wherein the training dataset comprises a plurality of raw input datasets, wherein the training dataset comprises a plurality of respective view directions and a plurality of respective positions;
processing a first view direction and a first position with a neural radiance field model to generate first predicted data, wherein the first predicted data is descriptive of one or more first predicted color values and one or more first predicted density values;
evaluating a loss function that evaluates a difference between the first predicted data and a first raw input dataset of the plurality of raw input datasets, wherein the first raw input dataset is associated with at least one of the first position or the first view direction; and
adjusting one or more parameters of the neural radiance field model based at least in part on the loss function.

18. The one or more non-transitory computer-readable media of claim 17, wherein the one or more parameters are associated with a learned three-dimensional representation associated with an environment.

19. The one or more non-transitory computer-readable media of claim 17, wherein the loss function comprises a tone-mapping loss associated with processing at least one of the first predicted data or the first raw input dataset.

20. The one or more non-transitory computer-readable media of claim 17, wherein the operations further comprise:
processing a second view direction and a second position with the neural radiance field model to generate second predicted data, wherein the second predicted data is descriptive of one or more second predicted color values and one or more second predicted density values;
scaling the one or more second predicted color values based on a shutter speed to generate scaled second predicted data;
evaluating the loss function that evaluates the difference between the scaled second predicted data and a second raw input dataset of the plurality of raw input datasets, wherein the second raw input dataset is associated with at least one of the second position or the second view direction; and
adjusting one or more additional parameters of the neural radiance field model based at least in part on the loss function.
